(19) United States
(12) Patent Application Publication
(10) Pub. No.: US 2025/0052578 A1
(43) Pub. Date: Feb. 13, 2025

(54) TAG DEVICE FOR RECOGNIZING MOTION, MOTION RECOGNIZER, AND METHOD OF OPERATING THE TAG DEVICE

(71) Applicant: SAMSUNG ELECTRONICS CO., LTD., Suwon-si (KR)

(72) Inventors: Hyunsoon KIM, Suwon-si (KR); Hwangnam KIM, Seoul-si (KR); Jun KIM, Suwon-si (KR); Seungchull SUH, Suwon-si (KR); Kyeonghyun YOO, Seoul-si (KR); Dongjae LEE, Seoul-si (KR)

(73) Assignees: SAMSUNG ELECTRONICS CO., LTD., Suwon-si (KR); Korea University Research And Business Foundation, Seoul (KR)

(21) Appl. No.: 18/796,834

(22) Filed: Aug. 7, 2024

(30) Foreign Application Priority Data
Aug. 10, 2023 (KR) 10-2023-0105105
Nov. 30, 2023 (KR) 10-2023-0171818

(51) Int. Cl. G01C 21/14; G01P 13/00; G06T 7/277

(52) U.S. Cl. CPC G01C 21/14; G01P 13/00; G06T 7/277; G06T 2207/20084

(57) ABSTRACT

There is provided a tag device including a first sensor, a second sensor, a pre-processor and a neural network processor. The pre-processor generates first position data of the tag device based on time information sensed by at least one of a third sensor included in each of the one or more anchor devices and the first sensor of the tag device, generates second position data based on first speed data of the tag device sensed by the second sensor and the first position data, and generates an image based on a path of movement of the tag device based on the second position data in an operation period, and the neural network processor classifies the image into one of a plurality of movements by using a trained neural network model.

### CROSS-REFERENCE TO RELATED APPLICATION

This application is based on and claims priority under 35 U.S.C. § 119 to Korean Patent Application No. 10-2023-0105105, filed on Aug. 10, 2023, and Korean Patent Application No. 10-2023-0171818, filed on Nov. 30, 2023, in the Korean Intellectual Property Office, the disclosures of which are incorporated by reference herein in their entireties.

### BACKGROUND

The disclosure relates to a tag device, and more particularly, to a tag device and a motion recognizer for recognizing motion of a tag device by using a first sensor and a second sensor.

As technology of electronic devices develops, there is an inconvenience of having to go through several stages in order to use functions desired by a user. Therefore, motion recognition technology is being developed to recognize user's motion to control a device and increase user convenience.

Motion recognition technology includes optical and non-optical methods. In the optical method, a camera and an image sensor are used to detect movement and motion of an object or a user to be recognized. The optical method requires a large amount of calculation and may be affected by other objects (e.g., visual elements) in a surrounding environment. In the non-optical method, an inertial measurement unit (IMU) sensor is used to detect movement and motion of an object or a user to be recognized. The non-optical method requires a large amount of calculation and may have low motion recognition accuracy.

Accordingly, technology is required to improve the motion recognition accuracy while reducing an amount of calculation required for motion recognition.

### SUMMARY

Example embodiments provide a tag device for improving motion recognition performance by generating final position data by using position data of the tag device generated by using a first sensor and speed data of the tag device generated by using a second sensor and recognizing motion represented by the final position data by using a neural network model and a method of operating the same.

According to an aspect of the disclosure, there is provided a tag device communicating with one or more anchor devices, the tag device including: a first sensor; a second sensor; a pre-processor configured to: generate first position data of the tag device based on time information sensed by at least one of a third sensor included in each of the one or more anchor devices and the first sensor of the tag device, generate second position data based on first speed data of the tag device sensed by the second sensor and the first position data, and generate an image based on a path of movement of the tag device based on the second position data in an operation period; and a neural network processor configured to classify the image into one of a plurality of movements by using a trained neural network model.

According to another aspect of the disclosure, there is provided a motion recognizer including: a memory storing a program; and at least one processor configured to execute the program to: receive time information of a tag device from a first sensor and generate first position data of the tag device, the first position data including position values at a plurality of points in time included in an operation period, receive first speed data of the tag device from a second sensor, the first speed data including acceleration values at the plurality of points in time and generates second position data of the operation period based on the position data and the first speed data, generate an image based on a path of movement of the tag device based on the second position data of the operation period, and classify the image into one of a plurality of movements by using a trained neural network model.

According to an aspect of the disclosure, there is provided a method of operating a tag device, the method including: receiving time information of a tag device from a first sensor and generate first position data of the tag device, the first position data including position values at a plurality of points in time included in an operation period, receiving first speed data of the tag device from a second sensor, the first speed data including acceleration values at the plurality of points in time and generates second position data of the operation period based on the position data and the first speed data, generating an image based on a path of movement of the tag device based on the second position data of the operation period, and classifying the image into one of a plurality of movements by using a trained neural network model.

### BRIEF DESCRIPTION OF DRAWINGS

The above and/or other aspects will be more clearly understood from the following detailed description taken in conjunction with the accompanying drawings in which:

FIG. 1A is a diagram illustrating a motion recognition system according to an embodiment;

FIG. 1B is a diagram illustrating a motion recognition system including a second electronic device according to an embodiment;

FIG. 2A is a block diagram illustrating a second electronic device according to an embodiment;

FIG. 2B is a block diagram illustrating a second electronic device according to an embodiment;

FIG. 3 is a block diagram illustrating a first electronic device according to an embodiment;

FIG. 4 is a diagram illustrating an arrangement of one or more first electronic devices and a second electronic device according to an embodiment;

FIG. 5 is a diagram illustrating a method of generating position data according to an embodiment;

FIG. 6 is a diagram illustrating a motion path of a second electronic device according to an embodiment;

FIG. 7 is a diagram illustrating an operation period according to an embodiment;

FIG. 8 is a flowchart illustrating a motion recognition method according to an embodiment;

FIG. 9 is a flowchart illustrating a method of operating a pre-processor according to an embodiment;

FIG. 10 is a diagram illustrating a method of generating final position data according to an embodiment;

FIG. 11 is a diagram illustrating a method of generating an image according to an embodiment;

FIG. 12 is a diagram illustrating a neural network model according to an embodiment; and

FIG. 13 is a block diagram illustrating a motion recognizer according to an embodiment.

### DETAILED DESCRIPTION

Hereinafter, example embodiments of the disclosure will be described in detail with reference to the accompanying drawings. Like reference numerals refer to like elements, and their repetitive descriptions are omitted.

The following specific embodiments are provided to assist readers in obtaining a full understanding of methods, devices, and/or systems described herein. However, various changes, modifications, and equivalents of the methods, devices, and/or systems described herein will be clear upon understanding the disclosure of the present application. For example, orders of operations described herein are merely exemplary and the disclosure is not limited to those set forth herein, but rather may be altered as will be clear upon an understanding of the disclosure of the present application, except for operations that must occur in a particular order. In addition, descriptions of features known in the art may be omitted for greater clarity and brevity.

The features described herein may be implemented in different forms and should not be construed as being limited to examples described herein. Rather, the examples described herein have been provided to illustrate only some of many feasible ways of realizing the methods, devices, and/or systems described herein, many feasible ways will be clear upon an understanding of the disclosure of the present application.

The terms used herein are used only to describe various examples and will not be used to limit the disclosure. Unless the context clearly indicates otherwise, the singular form is also intended to include the plural form. The terms “comprising,” “including,” and “having” indicate the presence of recited features, quantities, operations, components, elements, and/or combinations thereof, but do not preclude the presence or addition of one or more other features, quantities, operations, components, elements, and/or combinations thereof.

Unless otherwise defined, all terms used herein, including technical and scientific terms, have the same meanings as those commonly understood by those of ordinary skill in the art to which the disclosure pertains after understanding the disclosure. Unless expressly so defined herein, terms (e.g., terms defined in a general-purpose dictionary) should be interpreted as having a meaning consistent with their meaning in the context of the relevant field and the disclosure, and should not be interpreted ideally or in an overly formalistic manner.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all example embodiments are not limited thereto.

The embodiments of the disclosure are example embodiments, and thus, the disclosure is not limited thereto, and may be realized in various other forms. As is traditional in the field, embodiments may be described and illustrated in terms of blocks, as shown in the drawings, which carry out a described function or functions. These blocks, which may be referred to herein as units or modules or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

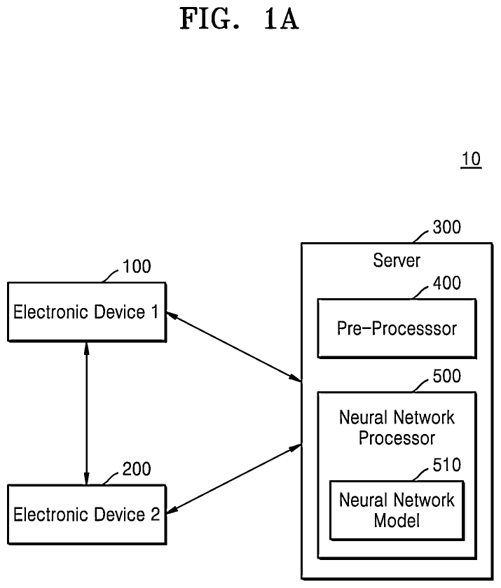

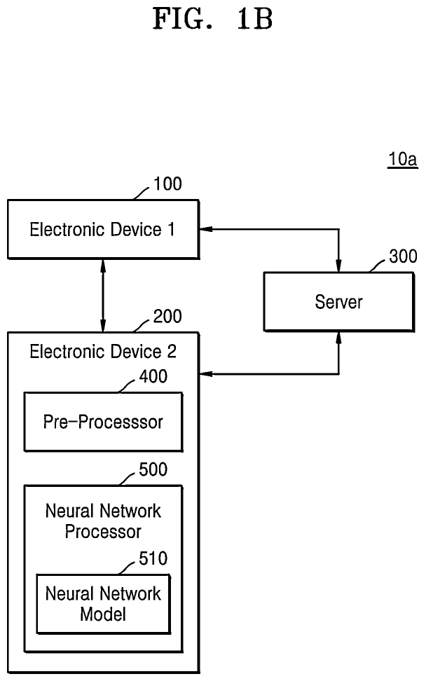

FIG. 1A is a diagram illustrating a motion recognition system 10 according to an embodiment.

According to an embodiment, the motion recognition system 10 may include a first electronic device 100 and the second electronic device 200. However, the disclosure is not limited thereto, and as such, according to another embodiment, the motion recognition system 10 may include more than two electronic devices. The motion recognition system 10 may recognize movement of a second electronic device 200. The motion recognition system 10 may include a server 300, a pre-processor 400, and a neural network processor 500. According to an embodiment illustrated in FIG. 1A, the pre-processor 400 and the neural network processor 500 are illustrated as being included in the server 300. However, the disclosure is not limited thereto, and at least one of the pre-processor 400 and the neural network processor 500 may be included in the first electronic device 100 or the second electronic device 200, or may be included in another electronic device (e.g., a third electronic device).

The first electronic device 100 may be an anchor device. Although one first electronic device 100 is illustrated in FIG. 1A, the disclosure is not limited thereto, and the motion recognition system 10 may include a plurality of first electronic devices 100. As such, the motion recognition system 10 may include a plurality of anchor devices. The first electronic device 100 may be arranged at a designated position to transmit and receive a signal to and from the second electronic device 200. For example, the first electronic device 100 may be installed in a specific space. In an example case in which four first electronic devices 100 are in the motion recognition system 10, the four first electronic devices 100 may be arranged at designated positions in a vehicle.

The electronic device according to embodiments of the disclosure may include a fixed terminal or a mobile terminal implemented as a computer device, and may communicate with other devices and/or the server 300 by using a wireless or wired communication method. For example, the electronic device may be implemented as a personal computer (PC), an Internet of things (IoT) device, or a portable electronic device. The portable electronic device may include a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, a digital TV, a refrigerator, an artificial intelligence speaker, a projector, a smart key, a smart car, or a printer. In addition, the electronic device may be mounted on an electronic device such as a drone or an advanced driver assistance system (ADAS) or an electronic device equipped as parts for a vehicles, furniture, manufacturing facilities, doors, and various measurement devices.

The second electronic device 200 may be a tag device. The second electronic device 200 may be movable. The second electronic device 200 may move together with a user or an object. For example, the second electronic device 200 may be implemented as a wearable device and may be attached to a user to move. The motion recognition system 10 may control a device by recognizing motion of a user, the second electronic device 200 being attached to the user. For example, the second electronic device 200 may be attached to a user riding in a vehicle, and the motion recognition system 10 may recognize the user's gesture or motion through a position of the second electronic device 200 to control the vehicle.

The first electronic device 100 and the second electronic device 200 may communicate with each other. For example, the first electronic device 100 and the second electronic device 200 may communicate with each other by using an ultra-wideband (UWB) communication network. UWB may refer to a short-range, high-speed wireless communication technology that utilizes a wide frequency band of several GHz or more, low spectral density, and a short pulse width (e.g., 1 to 4 nsec) in a baseband state. UWB may also refer to a band itself to which UWB communication is applied.

The first electronic device 100 and the second electronic device 200 may transmit and receive a UWB signal to and from each other through the UWB communication network, and may record a time for transmitting and receiving the UWB signal. For example, the first electronic device 100 and the second electronic device 200 may periodically receive data of a specific format or may periodically check whether a signal of a specific format is received. In an example case in which there are a plurality of first electronic devices 100, each of the plurality of first electronic devices 100 may transmit and receive the UWB signal to and from the second electronic device 200. At least one of the first electronic device 100 and the second electronic device 200 may provide time information to the pre-processor 400. The time information may refer to information representing a time for the first electronic device 100 and the second electronic device 200 to transmit and receive the UWB signal to and from each other through the UWB communication network.

The server 300 may generally control the motion recognition system 10. In an embodiment, a signal may be transmitted and received between the first electronic device 100 and the second electronic device 200 through the server 300. The server 300 may be an independent electronic device. The first electronic device 100, the second electronic device 200, and the server 300 may be wirelessly connected. However, the disclosure is not limited thereto, and at least one of the first electronic device 100 and the second electronic device 200 and the server 300 may be connected by wire.

The pre-processor 400 may generate position data. The pre-processor 400 may receive the time information from at least one of the first electronic device 100 and the second electronic device 200. Each of the first electronic device 100 and the second electronic device 200 may include a first sensor, and may receive the time information sensed by at least one of the first sensor of the first electronic device 100 and the first sensor of the second electronic device 200. The time information may refer to a time for at least one of the first electronic device 100 and the second electronic device 200 to transmit and receive the UWB signal. The pre-processor 400 may generate position data of the second electronic device 200 based on the time information.

The pre-processor 400 may calculate a distance between the first electronic device 100 and the second electronic device 200 based on the time information. In an example case in which there are a plurality of first electronic devices 100, the pre-processor 400 may receive time information between each of the plurality of first electronic devices 100 and the second electronic device 200, and may calculate a distance between each of the plurality of first electronic devices 100 and the second electronic device 200 based on the time information. The pre-processor 400 may generate the position data of the second electronic device 200 by using the distance between the first electronic device 100 and the second electronic device 200.

The second electronic device 200 may be a mobile device. The second electronic device 200 may move independently or may be attached to a user or an object and move along with the user or the object. In the operation period, the second electronic device 200 may move and the position of the second electronic device 200 may change. In an example case in which the position of the second electronic device 200 changes, the distance between the first electronic device 100 and the second electronic device 200 may change. The operation period may be a period in which motion of the second electronic device 200 is to be recognized. The operation period is a continuous specific time period and may be preset in the motion recognition system 10 or may be set by the user. For example, the second electronic device 200 may receive a user input representing a start and a user input representing an end, and a time period between the start and the end may be set as the operation period.

The pre-processor 400 may generate position values. The position data may include position values at a plurality of points in time. The position values at the plurality of points in time correspond to the plurality of points in time, respectively, and may mean the position of the second electronic device 200 at each of the plurality of points in time. The operation period may include the plurality of points in time.

In an example case in which the second electronic device 200 moves in the operation period, position values of the second electronic device 200 may change with time. The pre-processor 400 may calculate a position value at a specific point in time. The pre-processor 400 may calculate the distance between the first electronic device 100 and the second electronic device 200 at the plurality of points in time, and may generate the position value of the second electronic device 200 at each of the plurality of points in time based on the distance. For example, the pre-processor 400 may generate the position value of the second electronic device 200 at regular intervals. The position values of the second electronic device 200 in the operation period of the second electronic device 200 may represent the motion of the second electronic device 200. The motion recognition system 10 may recognize the motion of the second electronic device 200 based on the position values.

The pre-processor 400 generates the position values based on the time information, and may include abnormal position values due to external environmental factors or communication interference. In an example case in which the abnormal position values are included in the position data, the motion of the second electronic device 200 may not appear accurately. The abnormal position values need to be removed from the position data. The pre-processor 400 may generate final position data obtained by removing abnormal position data from the position data.

The pre-processor 400 may generate the final position data based on at least one of first speed data and the position data. The first speed data may include an acceleration value of the second electronic device 200 measured by a second sensor to calculate a speed value of the second electronic device 200. The second electronic device 200 may include the second sensor. The first speed data may include acceleration values of the second electronic device 200 at each of the plurality of points in time. In an embodiment, the pre-processor 400 may generate the final position data based on the first speed data. The pre-processor 400 may calculate the speed value of the second electronic device 200 at each of the plurality of points in time based on the first speed data. The pre-processor 400 may identify the abnormal position data based on the calculated speed value of the second electronic device 200 and may generate the final position data.

In an embodiment, the pre-processor 400 may generate the final position data based on the position data of the second electronic device 200 and a position of the first electronic device 100. The pre-processor 400 may identify the abnormal position data based on the position of the first electronic device 100.

In an embodiment, the pre-processor 400 may generate the final position data based on the first speed data and the position of the first electronic device 100. The pre-processor 400 may identify first abnormal position data in the position data based on the first speed data. The pre-processor 400 may identify second abnormal position data in the position data based on the position of the first electronic device 100. The pre-processor 400 may generate the final position data based on the first abnormal position data and the second abnormal position data. For example, the pre-processor 400 may generate the final position data by removing the first abnormal position data and the second abnormal position data from the position data.

The pre-processor 400 may convert a motion path of the second electronic device 200 represented by the final position data into an image in the operation period. In the operation period, final position values corresponding to the plurality of points in time may represent the motion path of the second electronic device 200. For example, the pre-processor 400 may convert the motion of the second electronic device 200 into an image based on a graph representing final position values at a plurality of points in time. According to an embodiment, the pre-processor 400 may include one or more of a central processing unit (CPU), an application processor (AP), and a communication processor (CP). However, the disclosure is not limited thereto, and as such, according to another embodiment, the pre-processor 400 may be implemented by various electronic components and circuits.

The first speed data may be obtained by the second sensor, and the final position data from which the abnormal position data is removed may be generated. The final position data including the final position values in the operation period may indicate normal motion of the second electronic device 200. Because the motion recognition system 10 recognizes the motion of the second electronic device 200 based on the final position data, the motion recognition accuracy may be improved.

The neural network processor 500 may receive input data, may perform an operation based on a neural network model 510, and may provide output data based on the operation result. The input data of the neural network processor 500 may be an image, and the output data may be a classification result obtained by classifying the image according to motion. The image generated by the pre-processor 400 may be input to the neural network processor 500.

The neural network processor 500 may generate a neural network model, may train or learn the neural network model, may perform an operation based on received input data, may generate an information signal based on the operation result, or may retrain or update the neural network model. The neural network processor 500 may process an operation based on various types of networks such as a convolution neural network (CNN), a region with a convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), restricted Boltzman machine (RBM), a fully convolutional network, a long short-term memory (LSTM) network, and a classification network. However, the disclosure is not limited thereto, and various types of computational processing that simulates human neural networks may be performed.

The neural network processor 500 may be implemented as a neural network operation accelerator, a coprocessor, a digital signal processor (DSP), an application specific integrated circuit (ASIC), a field-programmable gate array (FPGA), a graphics processing unit (GPU), a neural processing unit (NPU), a tensor processing unit (TPU), or a multi-processor system-on-chip (MPSoC).

The neural network processor 500 may include one or more processors to perform operations according to neural network models. In addition, the neural network processor 500 may include separate memory for storing programs corresponding to the neural network models. The neural network processor 500 may be referred to as a neural network processing device, a neural network integrated circuit, or a neural network processing unit (NPU).

The neural network processor 500 may recognize the motion of the second electronic device 200 by using the neural network model 510. The neural network model 510 may be a model trained to classify motion represented by an image. The neural network model 510 may infer which motion the image belongs to. For example, the neural network processor 500 may classify a first image as belonging to first motion by using the neural network model 510. That is, the neural network processor 500 may recognize the motion of the second electronic device 200 generated by the first image as the first motion. By recognizing the motion of the second electronic device 200 by using the neural network model 510, the motion of the second electronic device 200 may be recognized accurately and quickly.

The neural network model 510 may be trained and generated by a training device (e.g., a server that trains a neural network based on a large amount of input data), and the trained neural network model 510 may be executed by the neural network processor 500. However, embodiments of the disclosure are not limited thereto, and the neural network model 510 may be trained by the neural network processor 500.

In an embodiment, the pre-processor 400 and the neural network processor 500 may be included in the server 300. The server 300 may receive the time information from at least one of the first electronic device 100 and the second electronic device 200, and may generate the position data of the second electronic device 200 based on the time information. The server 300 may generate the final position data of the operation period based on the first speed data. The server 300 may convert the motion path of the second electronic device 200 into an image based on the final position data, and may recognize the motion of the second electronic device 200 by using the neural network model 510. However, the disclosure is not limited thereto, and one of the pre-processor 400 and the neural network processor 500 may be included in the server 300, or the pre-processor 400 and the neural network processor 500 may not be included in the server 300. In addition, the pre-processor 400 and the neural network processor 500 are illustrated as separate components in FIG. 1. However, embodiments of the disclosure are not limited thereto and the pre-processor 400 and the neural network processor 500 may be implemented as a single chip.

FIG. 1B is a diagram illustrating a motion recognition system 10a including a second electronic device 200 according to an embodiment. Compared with FIG. 1A, the second electronic device 200 may include a pre-processor 400 and a neural network processor 500. Similar details as described above with respect to FIG. 1A may be omitted for brevity.

Referring to FIG. 1B, the motion recognition system 10a may include a first electronic device 100 and a second electronic device 200. The second electronic device 200 may include the pre-processor 400 and the neural network processor 500. The second electronic device 200 may receive time information from the first electronic device 100, or may use time information sensed by a second sensor of the second electronic device 200. The second electronic device 200 may generate position data of the second electronic device 200 based on the time information.

The second electronic device 200 may generate final position data of an operation period based on first speed data. The second electronic device 200 may generate the final position data from the position data based on at least one of the first speed data and the position data of the second electronic device 200 sensed by the second sensor. The second electronic device 200 may convert a motion path of the second electronic device 200 into an image based on the final position data, and may recognize motion of the second electronic device 200 by using a neural network model 510. However, embodiments of the disclosure are not limited thereto, and one of the pre-processor 400 and the neural network processor 500 may be included in the second electronic device 200, or the pre-processor 400 and the neural network processor 500 may not be included in the second electronic device 200. At least one of the pre-processor 400 and the neural network processor 500 may be included in another electronic device (e.g., the first electronic device).

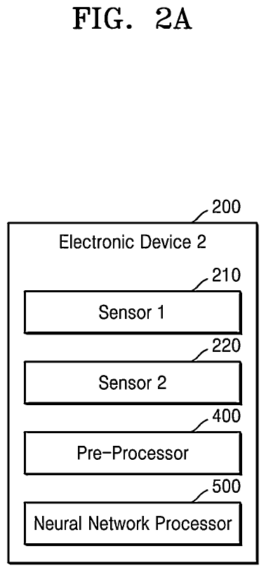

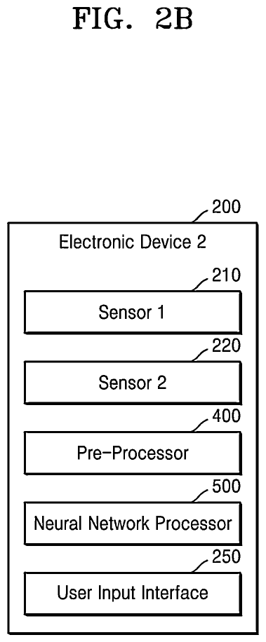

FIG. 2A is a block diagram illustrating a second electronic device 200 according to an embodiment. Similar details as described above with respect to FIGS. 1A and 1B may be omitted for brevity.

Referring to FIG. 2A, the second electronic device 200 may include a first sensor 210, a second sensor 220, a pre-processor 400, and a neural network processor 500. Although it is illustrated in FIG. 2A that the second electronic device 200 includes the first sensor 210, the second sensor 220, the pre-processor 400, and the neural network processor 500, embodiments of the disclosure are not limited thereto and the second electronic device 200 may further include other components as needed.

The first sensor 210 may sense a time for the first electronic device (e.g., the first electronic device 100 of FIG. 1A) and the second electronic device 200 to transmit and receive a UWB signal. For example, the UWB signal may be transmitted and received to and from the first sensor of the first electronic device and the first sensor 210 of and the second electronic device 200. In an embodiment, the first sensor 210 may be a UWB sensor. The UWB sensor may measure a time at which a signal is transmitted and received. The UWB sensor may generate time information.

The second sensor 220 may generate first speed data of the second electronic device 200. The first speed data may include acceleration values of the second electronic device 200. The second sensor 220 may measure an acceleration value of the second electronic device 200. The second sensor 220 may measure the acceleration value of the second electronic device 200 corresponding to each of a plurality of points in time.

In an embodiment, the second sensor 220 may be an IMU sensor. The IMU sensor may include an acceleration sensor, a gyro sensor, or a geomagnetic sensor. However, embodiments of the disclosure are not limited thereto, and the IMU sensor may further include another sensor. The acceleration sensor may measure acceleration and tilt angle. The gyro sensor may measure an angular change in rotational movement on one axis or multiple axes. The geomagnetic sensor may measure a direction by using a geomagnetic field. The IMU sensor may measure a first speed value of the second electronic device 200 corresponding to each of the plurality of points in time by using at least one of the acceleration sensor, the gyro sensor, and the geomagnetic sensor. For example, the IMU sensor may generate the first speed value of the second electronic device 200 based on the acceleration of the second electronic device 200 measured by the acceleration sensor.

The pre-processor 400 may generate position data. The pre-processor 400 may receive time information sensed by at least one of the first sensor of the first electronic device (e.g., the first electronic device 100 of FIG. 1B) and the first sensor 210 of the second electronic device 200. The pre-processor 400 may calculate a distance between each of the plurality of first electronic devices 100 and the second electronic device 200 based on the time information. The pre-processor 400 may generate position data of the second electronic device 200 by using the distance between the first electronic device 100 and the second electronic device 200. The pre-processor 400 may generate final position data obtained by removing abnormal position data from the position data.

The pre-processor 400 may generate the final position data based on at least one of first speed data and the position data. The first speed data may include an acceleration value of the second electronic device 200 measured by the second sensor 220 to calculate a speed value of the second electronic device 200. The pre-processor 400 may identify the abnormal position data based on the calculated speed value of the second electronic device 200 and may generate the final position data.

The pre-processor 400 may convert a motion path of the second electronic device 200 represented by the final position data into an image in the operation period. An image generated by the pre-processor 400 may be input to the neural network processor 500. The neural network processor 500 may recognize motion of the second electronic device 200 by using a neural network model.

According to an embodiment, the second electronic device 200 may include a transceiver and a controller. The transceiver may transmit and receive data and a control command to and from an external device. The transceiver may transmit and receive a signal to and from the first electronic device. For example, the transceiver may transmit and receive the UWB signal to and from the first electronic device. The transceiver may transmit the time information to the first electronic device. The transceiver may transmit and receive data and a control command to and from a server. For example, the second electronic device 200 may receive the control command from the server through the transceiver to transmit and receive a signal to and from the first electronic device.

The controller may generally control the second electronic device 200. The controller may control components of the second electronic device 200.

FIG. 2B is a block diagram illustrating a second electronic device 200 according to an embodiment. Similar details as described above with respect to FIGS. 1A, 1B and 2A may be omitted for brevity.

The second electronic device 200 may include a first sensor 210, a pre-processor 400, and a neural network processor 500. Referring to FIG. 2B, the second electronic device 200 may further include a user input interface 250. The second electronic device 200 may receive information on a user input through the user input interface 250.

A motion recognition system (e.g., the motion recognition system 10a of FIG. 1B) may operate based on the user input. Start and end of the motion recognition system may be set based on the user input. In an embodiment, an operation period of the motion recognition system may be set based on the user input. The second electronic device 200 may receive the user input representing the start of the operation period through the user input interface 250. The second electronic device 200 may receive the user input representing the end of the operation period through the user input interface 250. The operation period may be set based on the user input representing the start and end.

In the operation period, the second electronic device 200 may transmit and receive a signal to and from the first electronic device and may transmit time information of the operation period. In an example case in which the operation period starts, the second electronic device 200 may transmit and receive a signal to and from the first electronic device, and a position value may be generated based on a point in time at which the signal is transmitted and received. The pre-processor (e.g., the pre-processor 400 of FIG. 1B) may generate position values at a plurality of points in time based on the time information of the operation period. In an example case in which the operation period ends, the pre-processor may not generate position values after an end point in time.

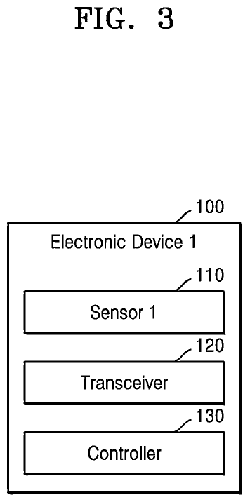

FIG. 3 is a block diagram illustrating a first electronic device 100 according to an embodiment. Similar details as described above with respect to FIGS. 1A, 1B, 2A and 2B may be omitted for brevity.

Referring to FIG. 3, the first electronic device 100 may include a first sensor 110, a transceiver 120, and a controller 130. Although it is illustrated in FIG. 3 that the first electronic device 100 includes the first sensor 110, the transceiver 120, and the controller 130, embodiments of the disclosure are not limited thereto, and the first electronic device 100 may further include other components as needed. For example, the first electronic device 100 may be an anchor device.

The first sensor 110 may sense a time for the first electronic device 100 and the second electronic device (for example, the second electronic device 200 of FIG. 1A) to transmit and receive a UWB signal. For example, the UWB signal may be transmitted and received to and from the first sensor 110 of the first electronic device 100 and the first sensor of and the second electronic device. In an embodiment, the first sensor 110 may be a UWB sensor. The UWB sensor may measure a time at which a signal is transmitted and received. The UWB sensor may generate time information.

The transceiver 120 may transmit and receive data and a control command to and from an external device. The transceiver 120 may transmit and receive a signal to and from the second electronic device. For example, the transceiver 120 may transmit and receive the UWB signal to and from the second electronic device. In addition, the transceiver 120 may transmit the time information to the pre-processor. The transceiver 120 may transmit and receive data and a control command to and from a server. For example, the first electronic device 100 may receive the control command from the server through the transceiver 120 to transmit and receive a signal to and from the second electronic device.

The controller 130 may generally control the first electronic device 100. The controller 130 may control components of the first electronic device 100.

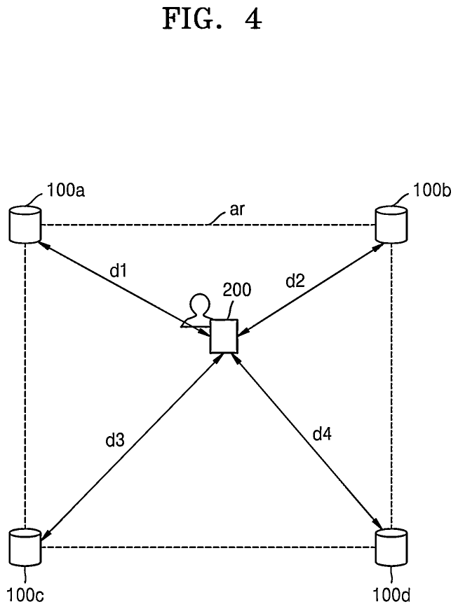

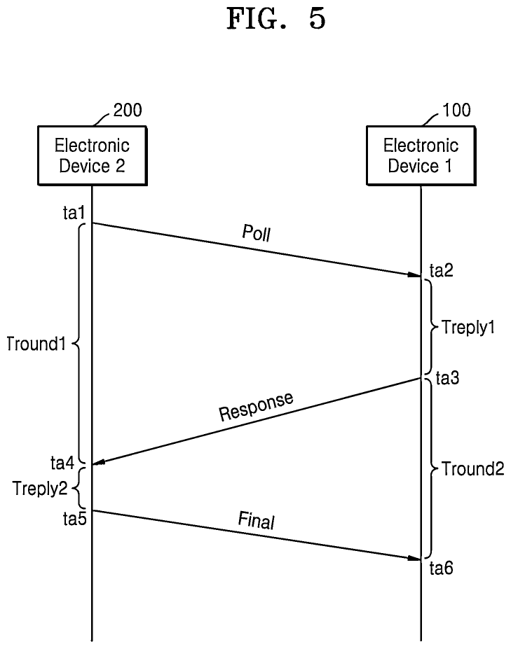

FIG. 4 is a diagram illustrating an arrangement of a plurality of first electronic devices 100 and a second electronic device 200 according to an embodiment. FIG. 5 is a diagram illustrating a method of generating position data according to an embodiment.

Referring to FIG. 4, a motion recognition system may include one or more first electronic devices 100. For example, the motion recognition may include a first first electronic device 100a, a second first electronic device 100b, a third first electronic device 100c, and a fourth first electronic device 100d. The motion recognition system may be the motion recognition system 10 of FIG. 1A or the motion recognition system 10a of FIG. 1B. The first first electronic device 100a, the second first electronic device 100b, the third first electronic device 100c, and the fourth first electronic device 100d may be arranged at specific positions. For example, the first first electronic device 100a, the second first electronic device 100b, the third first electronic device 100c, and the fourth first electronic device 100d may be arranged in a vehicle. However, embodiments of the disclosure are not limited thereto, and at least one of the first first electronic device 100a, the second first electronic device 100b, the third first electronic device 100c, and the fourth first electronic device 100d may be arranged outside the vehicle.

In an embodiment, the positions of the first first electronic device 100a, the second first electronic device 100b, the third first electronic device 100c, and the fourth first electronic device 100d may be fixed. However, embodiments of the disclosure are not limited thereto, and as such, according to another embodiment, one or more of the first first electronic device 100a, the second first electronic device 100b, the third first electronic device 100c, and the fourth first electronic device 100d may be movable, such that, a distance between the first first electronic device 100a, the second first electronic device 100b, the third first electronic device 100c, and the fourth first electronic device 100d may vary. The positions of each of the first first electronic device 100a, the second first electronic device 100b, the third first electronic device 100c, and the fourth first electronic device 100d may be transmitted to the pre-processor (e.g., the pre-processor 400 of FIG. 1B) through communication or may be pre-stored in the motion recognition system. For example, the first first electronic device 100a, the second first electronic device 100b, the third first electronic device 100c, and the fourth first electronic device 100d may be arranged in a square shape. However, embodiments of the disclosure are not limited thereto, and as such, according to another embodiment, the first first electronic device 100a, the second first electronic device 100b, the third first electronic device 100c, and the fourth first electronic device 100d may be arranged in a different shape. In another embodiment, the shape formed by the first first electronic device 100a, the second first electronic device 100b, the third first electronic device 100c, and the fourth first electronic device 100d may vary with respect to time.

The first first electronic device 100a, the second first electronic device 100b, the third first electronic device 100c, and the fourth first electronic device 100d may form an anchor region ar. The anchor region ar may refer to a region formed by at least one first electronic device 100, for example, in FIG. 4, the first first electronic device 100a, the second first electronic device 100b, the third first electronic device 100c, and the fourth first electronic device 100d. In an example case in which the first first electronic device 100a, the second first electronic device 100b, the third first electronic device 100c, and the fourth first electronic device 100d are arranged in a square shape, the anchor region ar may have a square shape. Although it is illustrated in FIG. 4 that there are four first electronic devices, the disclosure is not limited thereto and the motion recognition system may include various numbers of first electronic devices. Although FIG. 4 illustrates that the anchor region ar may have a square shape, embodiments of the disclosure are not limited thereto, and as such, the anchor region ar may have another shape. According to another embodiment, the anchor region ar may dynamically change with respect to time. For example, the anchor region ar may dynamically change with respect to time based on a movement of one or more of the electronic devices 100, removal of one or more of the electronic devices 100, or addition of one or more of the electronic devices 100. However, the disclosure is not limited thereto.

For example, the second electronic device 200 may move in the anchor region ar. The second electronic device 200 may move in the anchor region ar formed by the first first electronic device 100a, the second first electronic device 100b, the third first electronic device 100c, and the fourth first electronic device 100d.

Each of the first first electronic device 100a, the second first electronic device 100b, the third first electronic device 100c, and the fourth first electronic device 100d may transmit a UWB signal to the second electronic device 200 and/or receive a UWB signal from the second electronic device 200. The pre-processor 400 may generate position data based on time information. For example, the pre-processor 400 may generate position data based on time information obtained from the UWB signal. The pre-processor 400 may calculate distances d1 between the first first electronic device 100a and the second electronic device 200, d2 between the second first electronic device 100b and the second electronic device 200, d3 between the third first electronic device 100c and the second electronic device 200, and d4 between the fourth first electronic device 100d and the second electronic device 200 based on the time information. The pre-processor 400 may generate position data of the second electronic device 200 based on the distances d1, d2, d3, and d4.

Referring to FIGS. 4 and 5, the first electronic device 100 and the second electronic device 200 may transmit and receive the UWB signal between each other. The position data of the second electronic device 200 may be generated through message exchange between the first sensor of the first electronic device 100 and the first sensor of the second electronic device 200. For example, the motion recognition system may generate the position data by using a time of flight (ToF) method. However, the disclosure is not limited thereto, and a time difference of arrival (TDoA) method may be used. The first electronic device 100 of FIG. 5 may be one of the first first electronic device 100a, the second first electronic device 100b, the third first electronic device 100c, and the fourth first electronic device 100d of FIG. 4. The UWB signal may include a polling message Poll, a response message Response, and a final message Final.

According to an embodiment, the ToF method may be based on a point in time at which a signal is transmitted from the first electronic device 100 or the second electronic device 200, a point in time at which the signal arrives, and a speed at which the signal is transmitted. For example, the speed at which the signal is transmitted may be a speed of light. The motion recognition system may obtain a distance between the second electronic device 200 and a specific first electronic device 100 by using a time at which the signal transmitted by the second electronic device 200 arrives at the specific first electronic device 100 or a time at which the signal transmitted by the specific first electronic device 100 arrives at the second electronic device 200.

For example, the second electronic device 200 may transmit the polling message Poll to the first electronic device 100 at a point in time ta1. The second electronic device 200 may record the point in time ta1. The first electronic device 100 may receive the polling message Poll at a point in time ta2. The first electronic device 100 may record the point in time ta2. The first electronic device 100 may transmit the response message Response to the second electronic device 200 after a first response time Treply1. The first electronic device 100 may record a point in time ta3. The second electronic device 200 may receive the response message Response at a point in time ta4 at which the first electronic device 100 transmits the response message Response to the second electronic device 200. Here, the second electronic device 200 may transmit the polling message Poll and may receive the response message Response after a first round time Tround1. The second electronic device 200 may record the point in time ta4 at which the second electronic device 200 receives the response message Response.

The second electronic device 200 may receive the response message Response and may transmit the final message Final after a second response time Treply2. The second electronic device 200 may record a point in time ta5 at which the second electronic device 200 transmits the final message Final. The first electronic device 100 may receive the final message Final at a point in time ta6. The first electronic device 100 may transmit the response message Response and may receive the final message Final after a second round time Tround2. The first electronic device 100 may record the point in time ta6. The point in time recorded by at least one of the first electronic device 100 and the second electronic device 200 may be time information. Although it is illustrated in FIG. 5 that the second electronic device 200 transmits the polling message Poll, the disclosure is not limited thereto, and the first electronic device 100 may transmit the polling message Poll. Although the terms poll, response message and final message are used in describing the illustration in FIG. 5, embodiments of the disclosure are not limited thereto, and as such, other terms may be used to describe the transmitted signals and/or messages.

The motion recognition system may calculate ToF based on the time information, and may obtain a distance between the second electronic device 200 and a specific first electronic device 100 based on the ToF. For example, the pre-processor 400 may calculate the ToF by using Equation 1 below. However, Equation 1 corresponds to an example for calculating the ToF, and the ToF may be calculated in various ways.

$${t}_{ToF} = \frac{{T}_{round 1} \times {T}_{round 2} - {T}_{reply 1} \times {T}_{reply 2}}{{T}_{round 1} + {T}_{round 2} + {T}_{reply 1} + {T}_{reply 2}} \qquad Equation 1$$

wherein, t_{ToF} may refer to the ToF, Tround1 may refer to the first round time, Tround2 may refer to the second round time, Treply1 may refer to the first response time, and Treply2 may refer to the second response time.

The pre-processor 400 may calculate the distance between the second electronic device 200 and the specific first electronic device 100 by using Equation 2 below. For example, the pre-processor 400 may calculate the first distance d1 between the first first electronic device 100a and the second electronic device 200 by calculating the ToF of the first first electronic device 100a. The pre-processor 400 may calculate the second distance d2 between the second first electronic device 100b and the second electronic device 200 by calculating the ToF of the second first electronic device 100b. The pre-processor 400 may calculate the third distance d3 between the third first electronic device 100c and the second electronic device 200 by calculating the ToF of the third first electronic device 100c. The pre-processor 400 may calculate the fourth distance d4 between the fourth first electronic device 100d and the second electronic device 200 by calculating the ToF of the fourth first electronic device 100d.

$$d = c * {t}_{ToF} \qquad Equation 2$$

wherein, d may refer to the distance between the specific first electronic device 100 and the second electronic device 200, and c may refer to the speed of light.

The pre-processor 400 may generate position data based on a distance. The pre-processor 400 may generate the position data by using the first distance d1, the second distance d2, the third distance d3, and the fourth distance d4. The pre-processor 400 may estimate the position of the second electronic device 200 by using the first distance d1, the second distance d2, the third distance d3, and the fourth distance d4 and trilateration.

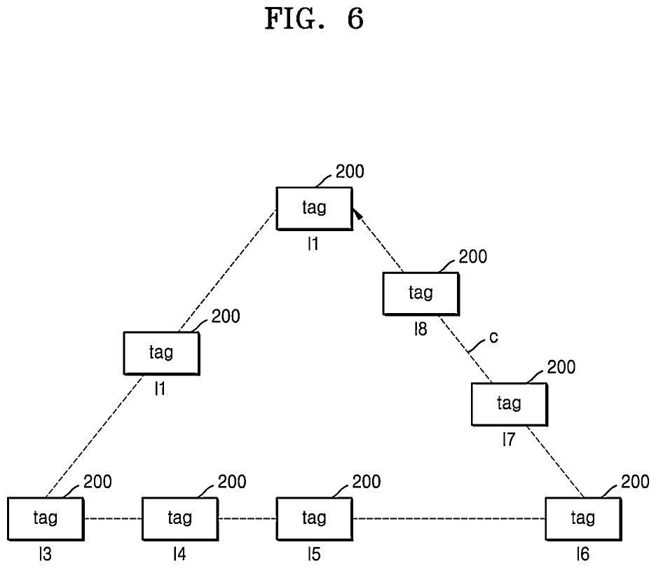

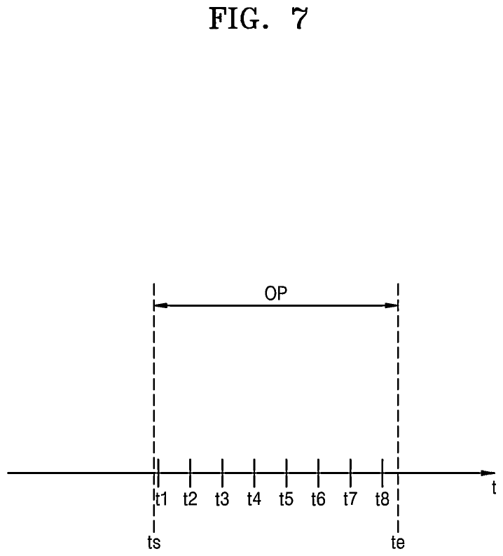

FIG. 6 is a diagram illustrating a motion path of a second electronic device 200 according to an embodiment. FIG. 6 two-dimensionally illustrates a path in which the second electronic device 200 moves. FIG. 7 is a diagram illustrating an operation period according to an embodiment. Hereinafter, FIGS. 6 and 7 are referred to together. Similar details as described above with respect to FIGS. 1-5 may be omitted for brevity.

Referring to FIGS. 6 and 7, the second electronic device 200 may move. The second electronic device 200 may move in an operation period OP. The second electronic device 200 may form a path c in the operation period OP. The operation period OP may refer to a time period from a start point in time ts to an end point in time te. The start point in time ts and the end point in time te may be designated based on a user input. However, the disclosure is not limited thereto, and the start point in time ts and the end point in time te may be preset.

The operation period OP may include a plurality of points in time. For example, the operation period OP may include first to eighth points in time t1 to t8. In FIG. 7, the operation period OP is illustrated as including the first to eighth points in time t1 to t8. However, embodiments of the disclosure are not limited thereto, and the operation period OP may include various numbers of points in time. For example, the plurality of points in time may be in units of milliseconds.

In an embodiment, the pre-processor (e.g., the pre-processor 400 of FIG. 1B) may generate position values of the second electronic device 200 at the plurality of points in time. The pre-processor may generate a position value representing a position of the second electronic device 200. A position value at a specific point in time may refer to position data corresponding to the specific point in time. The position of the second electronic device 200 at the first point in time t1 may be a first position 11. The first position 11 may be estimated by using the method described in FIGS. 4 and 5. The pre-processor may generate a first position value representing the first position 11. The position value of the second electronic device 200 may be the first position value at the first point in time t1.

The position of the second electronic device 200 may be a second position 12 at the second point in time t2. The pre-processor may generate a second position value representing the second position 12. The position value of the second electronic device 200 may be the second position value at the second point in time t2. The position of the second electronic device 200 may be an eighth position 18 at an eighth point in time t8. The pre-processor may generate an eighth position value representing the eighth position 18. The position value of the second electronic device 200 may be the eighth position value at the eighth point in time t8. A position value of each of the first to eighth points in time t1 to t8 may be included in position data.

In an embodiment, the pre-processor may generate final position data based on first speed data. The pre-processor may receive the first speed data. The first speed data may include acceleration values at a plurality of points in time. The pre-processor may calculate a first speed value of the second electronic device 200 at each of the plurality of points in time based on the first speed data. For example, the pre-processor may calculate first speed values of the second electronic device 200 at the first to eighth points in time t1 to t8. For example, the first speed value of the second electronic device 200 may be 3 m/s at the first point in time t1, and the first speed value of the second electronic device 200 may be 20 m/s at the sixth point in time t6. However, because 3 m/s and 20 m/s correspond to an example of the first speed value, the first speed value is not limited to the corresponding value.

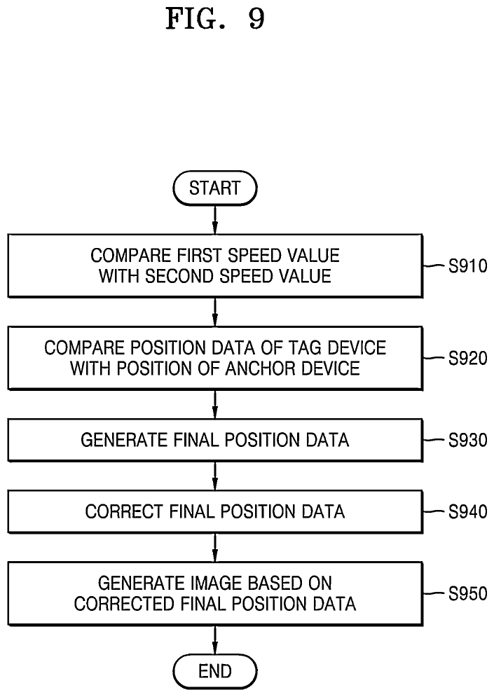

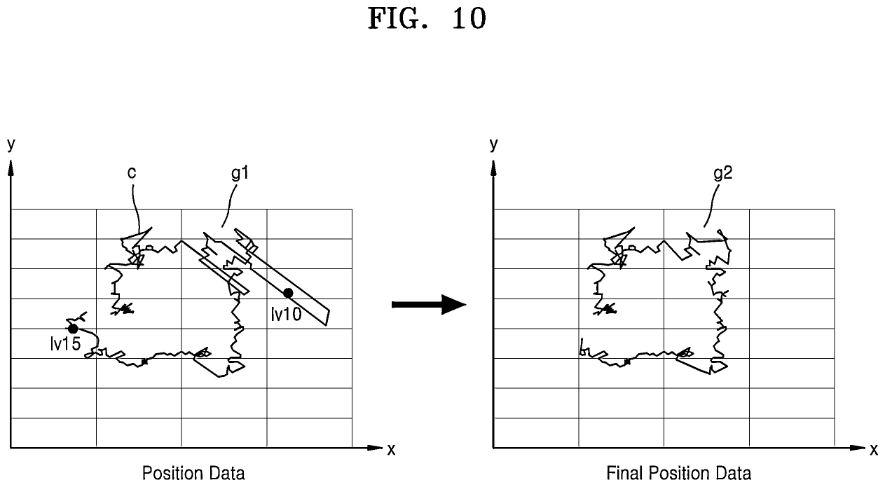

In an embodiment, the pre-processor may generate the final position data based on a second speed value. The pre-processor may generate the second speed value. The pre-processor may calculate second speed values of the second electronic device 200 based on position data. The pre-processor may know position values at the plurality of points in time, and may calculate the second speed values by using the position values at the plurality of points in time. For example, the pre-processor may calculate the second speed values of the second electronic device 200 at the first to eighth points in time t1 to t8. The final position data will be described in detail later with reference to FIGS. 9 and 10.

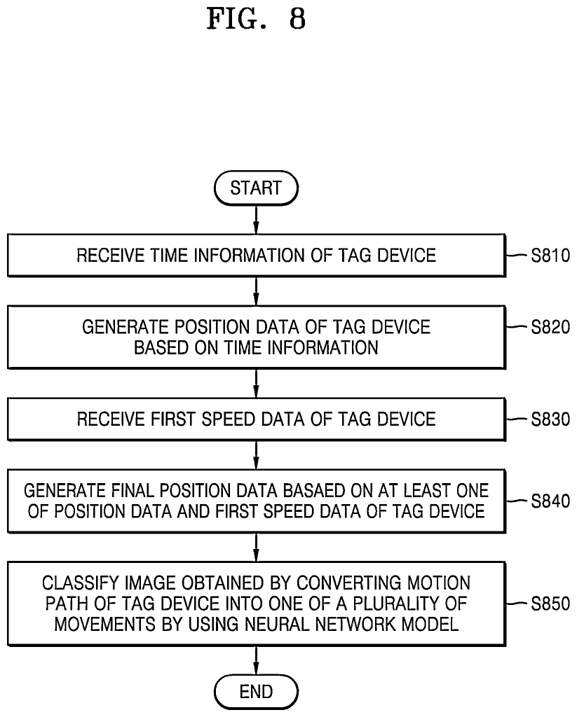

FIG. 8 is a flowchart illustrating a motion recognition method according to an embodiment. FIG. 8 illustrates a method of operating a tag device (for example, the second electronic device 200 of FIG. 1B). Similar details as described above with respect to FIGS. 1-7 may be omitted for brevity.

In operation S810, the method may include receiving time information corresponding to the tag device. For example, the pre-processor (e.g., the pre-processor 400 of FIG. 1B) may receive time information of the tag device. The pre-processor may receive the time information of the tag device from at least one of a first sensor of each of one or more anchor devices and a first sensor of the tag device. For example, the first sensor may be a UWB sensor. The anchor devices may be referred to as first electronic devices and the tag device may be referred to as a second electronic device.

In operation S820, the method may include generating position data of the tag device based on the time information. For example, the pre-processor may generate position data of the tag device based on the time information. The pre-processor may calculate a distance between a specific first electronic device and the second electronic device by using the time information. For example, the pre-processor may calculate a distance between each of the four first electronic devices and the second electronic device by using the time information. The pre-processor may generate the position data of the tag device by using triangulation and the distance between each of the four first electronic devices and the second electronic device.

In operation S830, the method may include receiving first speed data of the tag device. For example, the pre-processor may receive first speed data of the tag device. The pre-processor may receive the first speed data from a second sensor of the tag device. For example, the second sensor may be an IMU sensor. The first speed data may include acceleration values of the tag device measured by the IMU sensor. Operation S830 may follow or precede operation S820, or may be performed simultaneously with operation S810.

In operation S840, the method may include generating final position data based on at least one of the position data and the first speed data of the tag device. For example, the pre-processor may generate final position data based on at least one of the position data and the first speed data of the tag device. In an embodiment, the pre-processor may generate the final position data based on the position data and the first speed data of the tag device. The pre-processor may identify first abnormal position values based on the first speed data among position values included in the position data of the tag device. The pre-processor may calculate a first speed value of the tag device based on the first speed data. The pre-processor may calculate a second speed value of the tag device based on the position data. The pre-processor may identify the first abnormal position data by comparing the first speed value with the second speed value. The pre-processor may generate the final position data by removing the first abnormal position values from the position data.

In an embodiment, the pre-processor may generate the final position data based on the position data. The pre-processor may identify second abnormal position values among the position values included in the position data of the tag device based on the position data of the tag device and a position of the anchor device. The pre-processor may remove the second abnormal position values from the position data to generate the final position data.

In an embodiment, the pre-processor may identify the first abnormal position values and the second abnormal position values based on the position data and the first speed data of the tag device, and may remove the first abnormal position values and the second abnormal position values from the position data to generate the final position data.

In operation S850, the method may include classifying an image obtained based on the final position data into one of a plurality of movements. For example, a neural network processor may classify, by using a trained neural network model, an image in which a motion path of the tag device is converted into one of plurality of movements. In some embodiments, the neural network processor may classify the image in which a motion path of the tag device is converted into one of plurality of preset movements. The preset movements may also be referred to as preset movements, candidate movements or gesture movements, etc. Also, the plurality of movements may be referred to as a plurality of motions or a plurality of motion information. The final position data may represent the motion path of the tag device.

FIG. 9 is a flowchart illustrating a method of operating a pre-processor according to an embodiment. Operations of FIG. 9 may be performed after operation S830 of FIG. 8. For example, the operations of FIG. 9 may be included in operation S840 of FIG. 8. Similar details as described above with respect to FIGS. 1-8 may be omitted for brevity.

In operation S910, the method may include comparing a first speed value with a second speed value. For example, the pre-processor may compare a first speed value with a second speed value. The first speed value may be speed values of the tag device calculated by the pre-processor based on the first speed data. The second speed value may be speed values of the tag device calculated by the pre-processor based on the position data of the tag device. The pre-processor may know position values at the plurality of points in time, and may calculate the second speed values at the plurality of points in time.

The pre-processor may identify the first abnormal position data in the position data of the tag device based on the first speed data of the tag device. The pre-processor may identify the first abnormal position data by comparing the first speed value with the second speed value. The pre-processor may compare the first speed value with the second speed value at each of the plurality of points in time. The pre-processor may compare the first speed value of the tag device with the second speed value of the tag device at each of the plurality of points in time. For example, the pre-processor may compare the first speed value at the first point in time with the second speed value at the first point in time.

In an example case in which the second speed value corresponding to a target point in time is greater than the first speed value corresponding to a target point in time, the pre-processor may determine that position data corresponding to the target point in time corresponds to the first abnormal position data. The target point in time may refer to a point in time at which the pre-processor desires to compare the first speed value with the second speed value among the plurality of points in time. In an example case in which the pre-processor compares the first speed value with the second speed value at the current second point in time, the target point in time may be the second point in time. In an example case in which a speed calculated by the pre-processor based on the position data is higher than a speed measured by the second sensor of the tag device, the position data may be abnormal position data, which may be distinguished as the first abnormal position data.

In an example case in which the second speed value is greater than the first speed value at each of the plurality of points in time, a position value at the corresponding point in time may be the first abnormal position value. Position values at points in time at which the second speed value is greater than the first speed value among the plurality of points in time may be included in the first abnormal position data. For example, it is assumed that the second speed value at a first point in time is greater than the first speed value, the second speed value at a second point in time is less than the first speed value, and the second speed value at a third point in time is greater than the first speed value. The pre-processor may identify the position value at the first point in time and the position value at the third point in time as the first abnormal position value. The position value at the first point in time and the position value at the third point in time may be included in the first abnormal position data.

In operation S920, the method may include comparing the position data of the tag device with the position of the anchor device. For example, the pre-processor may compare the position data of the tag device with the position of the anchor device. The pre-processor may identify the second abnormal position data in the position data based on position values of the tag device at the plurality of points in time and the positions of the one or more anchor devices. The pre-processor may compare the position values at the plurality of points in time with a region formed by the one or more anchor devices. Hereinafter, the region formed by the one or more anchor devices will be referred to as the anchor region. The pre-processor may determine whether the position values at the plurality of points in time are included in the region formed by the anchor devices. For example, the pre-processor may determine whether the position value of the tag device at the first point in time is included in the anchor region.

The positions of the one or more anchor devices may be fixed, and the pre-processor may determine the region formed by the one or more anchor devices. In an example case in which there are four anchor devices, the region formed by the four anchor devices may refer to a region formed when the four anchor devices are connected to one another.

In an example case in which the position data of the tag device corresponding to the target point in time corresponds to the outside of the anchor region, the pre-processor may determine that the position data corresponding to the target point in time corresponds to the second abnormal position data. The position data corresponding to the target point in time may refer to a position value of the tag device at the target point in time. The tag device may move in the anchor region. In an example case in which the position of the tag device corresponds to the outside of the anchor region, a position value may be an abnormal position value, which may be distinguished as a second abnormal position value.

At each of the plurality of points in time, in an example case in which the position value of the tag device corresponds to the outside of the anchor region, the position value at the corresponding point in time may be the second abnormal position value. Position values corresponding to the outside of the anchor region among the plurality of points in time may be included in the second abnormal position data. For example, it is assumed that position values at a first point in time and a fifth point in time correspond to the outside of the anchor region, and position values at a second point in time to a fourth point in time correspond to the inside of the anchor region. The pre-processor may identify the position value at the first point in time and the position value at the fifth point in time as the second abnormal position value. The position values at the second to fourth points in time may not correspond to the second abnormal position value. The position value at the first point in time and the position value at the fifth point in time may be included in the second abnormal position data.

In FIG. 9, operation S920 is illustrated as following operation S910. However, the disclosure is not limited thereto, and operation S920 may be performed before operation S910, or operations S910 and S920 may be performed simultaneously. In addition, one of the operations S910 and S920 may be omitted.

In operation S930, the method may include generating the final position data. For example, the pre-processor may generate the final position data. The pre-processor may generate the final position data based on at least one of the first abnormal position data and the second abnormal position data. The pre-processor may generate the final position data by removing the abnormal position data from the position data of the tag device.

In an embodiment, the pre-processor may identify the first abnormal position data from the position data of the tag device, and may generate the final position data obtained by removing the first abnormal position data from the position data. In another embodiment, the pre-processor may identify the second abnormal position data from the position data of the tag device, and may generate the final position data obtained by removing the second abnormal position data from the position data. In another embodiment, the pre-processor may identify the first abnormal position data and the second abnormal position data from the position data of the tag device, and may generate the final position data obtained by removing the first abnormal position data and the second abnormal position data from the position data.

In operation S940, the method may include correcting correct the final position data. For example, the pre-processor may correct the final position data. In an example case in which the tag device moves, the tag device may be shaken due to external factors or user vibration, and such shaking may be included in the position data. Therefore, it is necessary to correct the shaking of the tag device due to external factors. In an embodiment, the pre-processor may correct the final position data by using a Kalman filter.

In operation S950, the method may include generating an image based on the corrected final position data. For example, the pre-processor may generate an image based on the corrected final position data. The corrected final position data may represent the motion path of the tag device in the operation period. The pre-processor may image the motion path of the tag device.

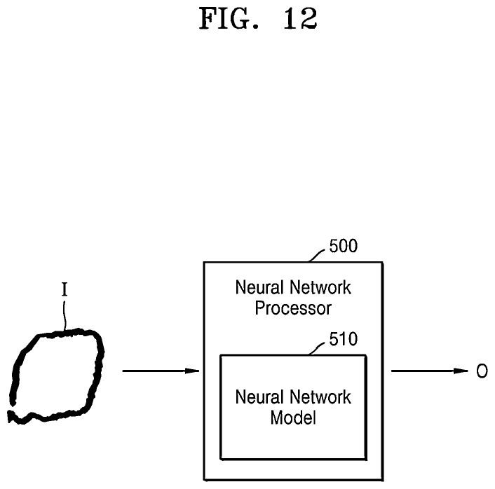

In an embodiment, the pre-processor may convert the motion path of the tag device into a gray scale image. The motion recognition system may recognize the motion of the tag device by using the image. A method of recognizing the motion of the tag device will be described later with reference to FIG. 12.

FIG. 10 is a diagram illustrating a method of generating final position data according to an embodiment. The left graph (“Position Data”) of FIG. 10 illustrates position data g1 of the tag device (second electronic device) in two dimensions. The position data g1 represents position values at a plurality of points in time. The right graph (“Final Position Data”) of FIG. 10 illustrates final position data g2 of the tag device in two dimensions. The final position data g2 may include position values from which at least one of the first abnormal position values and the second abnormal position values is removed. In FIG. 10, a horizontal axis represents a position in an x-axis direction, and a vertical axis represents a position in a y-axis direction. Similar details as described above with respect to FIGS. 1-9 may be omitted for brevity.

The tag device may move in the operation period. The tag device may form a path (c) in the operation period. The operation period may include a plurality of points in time. The position data g1 may include position values at the plurality of points in time. The pre-processor may generate the final position data g2 from the position data g1 based on at least one of the first speed data and the position data g1 of the tag device. In FIG. 10, it is assumed that the final position data g2 is generated based on the first abnormal position data and the second abnormal position data.

The pre-processor may calculate the first speed value based on the first speed data and may calculate the second speed value based on the position data. The pre-processor may identify the first abnormal position data by comparing the first speed value with the second speed value. The pre-processor may compare the first speed value with the second speed value at each of the plurality of points in time. The pre-processor may compare the first speed value of the tag device with the second speed value of the tag device at each of the plurality of points in time.

In an example case in which the second speed value at the target point in time is greater than the first speed value at the target point in time, the pre-processor may determine that the position value at the target point in time corresponds to the first abnormal position value. For example, the target point in time may be a tenth point in time, and the position value of the tag device at the tenth point in time may be a tenth position value lv10. The first speed value of the tag device at the tenth point in time may be obtained by the second sensor. The pre-processor may calculate the second speed value at the tenth point in time by using a position value at a point in time adjacent to the tenth point in time. Assuming that the second speed value at the tenth point in time is greater than the first speed value at the tenth point in time, the pre-processor may identify the tenth position value lv10 as the first abnormal position value. The tenth position value lv10 may be included in the first abnormal position data.

The pre-processor may compare the position data of the tag device with the position of the anchor device. The pre-processor may determine whether the position values at the plurality of points in time are included in the anchor region. In an example case in which the position value of the tag device at the target point in time corresponds to the outside of the anchor region, the pre-processor may determine that the position value at the target point in time corresponds to the second abnormal position value. For example, it is assumed that the target point in time is a 15th point in time, the position value of the tag device at the 15th point in time is a 15th position value lv15, and the position of the tag device at the 15th point in time is the outsider of the anchor region. Because the 15th position value lv15 corresponds to the outside of the anchor region, the pre-processor may identify the 15th position value lv15 as the second abnormal position value.

The pre-processor may generate the final position data g2 by removing the abnormal position data from the position data g1 of the tag device. The pre-processor may identify the first abnormal position data and the second abnormal position data from the position data g1 of the tag device, and may generate the final position data g2 by removing the first abnormal position data and the second abnormal position data from the position data g1. For example, the final position data g2 may not include the tenth position value lv10 and the 15th position value lv15.

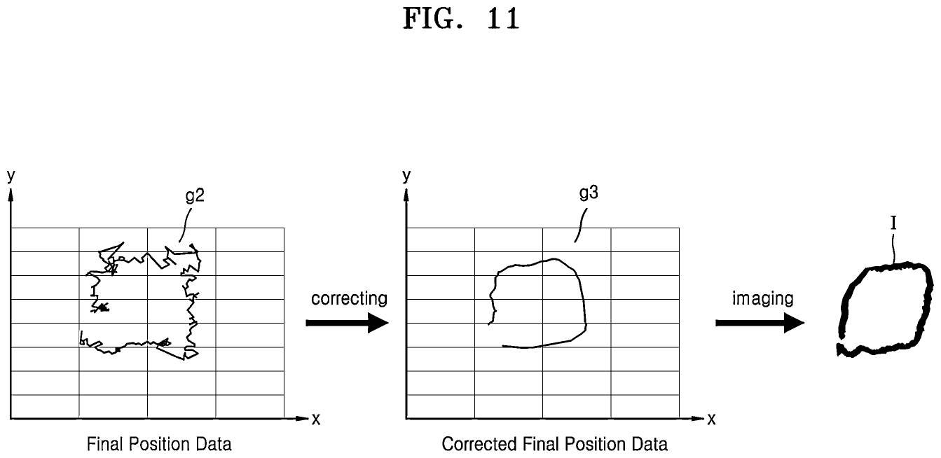

FIG. 11 is a diagram illustrating a method of generating an image according to an embodiment. Similar details as described above with respect to FIGS. 1-10 may be omitted for brevity. The left graph (“Final Position Data”) of FIG. 11 illustrates final position data g2 of the tag device in two dimensions. The right graph (“Corrected Final Position Data”) of FIG. 11 illustrates corrected final position data g3 of the tag device in two dimensions.

The pre-processor may correct the final position data g2. The pre-processor may correct the final position data g2 to generate corrected final position data g3. In an embodiment, the pre-processor may smooth the final position data g2 by using the Kalman filter. The corrected final position data g3 may be obtained by correcting the shaking of the tag device due to external factors in the final position data g2.

The pre-processor may generate an image I based on the corrected final position data g3. The corrected final position data g3 may represent the motion path of the tag device in the operation period. The pre-processor may generate the motion path of the tag device as the image I. For example, the image I may be generated based on a shape in which the final position values are displayed in two dimensions. In an embodiment, the image I may be a gray scale image from which color information is removed.

FIG. 12 is a diagram illustrating a neural network model 510 according to an embodiment. According to an embodiment, a neural network processor 500 and the neural network model 510 of FIG. 12 may correspond to the neural network processor 500 and the neural network model 510 of FIG. 1B, and as such, previously given description is omitted.

The neural network processor 500 may receive input data, may perform an operation based on a neural network model 510, and may provide output data based on the operation result. The input data of the neural network processor 500 may be the image I, and the output data O may be a classification result obtained by classifying the image according to motion. The image I generated by the pre-processor may be input to the neural network processor 500.

The neural network processor 500 may recognize the motion of the tag device (second electronic device) by using the neural network model 510. The neural network model 510 may be a model trained to classify motion represented by the image I. The neural network model 510 may infer which motion the image I belongs to. For example, the neural network processor 500 may classify the image I as belonging to rectangular motion by using the neural network model 510. The output data O may be output in a square shape. The neural network processor 500 may recognize the motion of the tag device as the rectangular motion. For example, the neural network processor 500 may classify the image I as belonging to triangular motion by using the neural network model 510. The neural network processor 500 may recognize the motion of the tag device as the triangular motion. However, the motion of the tag device is not limited to the rectangular motion and the triangular motion. The motion of the tag device may be accurately and quickly recognized by using the neural network model 510.

The neural network model 510 may be trained by a training device or the neural network processor 500. The neural network model 510 may be trained to output the output data O from the image I. The neural network model may be trained based on a training image. The training image may refer to a data set for training the neural network model 510 to classify which motion the image I belongs to. The training image may be in a form similar to the image I generated by the pre-processor.

In an embodiment, the trained neural network model 510 may be updated. For example, the neural network model 510 may be updated based on the image I. For example, because the neural network model 510 may not be previously trained on the image I generated by the pre-processor, the neural network model 510 may be updated so that the neural network model 510 may be applied to the image I. However, embodiments of the disclosure are not limited thereto, and as such, the neural network model 510 may be updated or retrained based on other imaged in combination with or without the image I. The neural network model 510 may be updated to infer motion from the image I of the same motion later.

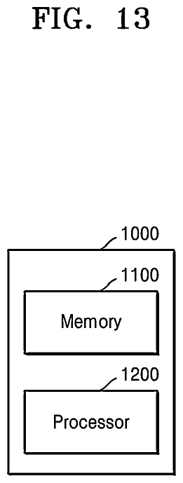

FIG. 13 is a block diagram illustrating a motion recognizer 1000 according to an embodiment. In an embodiment, the pre-processor 400 and the neural network processor 500 of FIG. 1A or 1B may be applied to a processor 1200. At least one of the pre-processor 400 and the neural network processor 500 may be included in the processor 1200. Similar details as described above with respect to FIGS. 1-12 may be omitted for brevity.

Referring to FIG. 13, the motion recognizer 1000 may include a memory 1100 and the processor 1200. The memory 1100 may store a program executed by the processor 1200. For example, the memory 1100 may include an instruction for the processor 1200 to recognize the motion of the tag device. The processor 1200 may recognize the motion of the tag device by executing the program.

The memory 1100 as a storage for storing data may store, for example, various algorithms, various programs, and various data. The memory 1100 may store one or more instructions. The memory 1100 may include at least one of volatile memory and non-volatile memory. The non-volatile memory may include read only memory (ROM), programmable ROM (PROM), electrically programmable ROM (EPROM), electrically erasable and programmable ROM (EEPROM), flash memory, phase-change random access memory (PRAM), magnetic RAM (MRAM), or resistive RAM (RRAM). The volatile memory may include dynamic RAM (DRAM), static RAM (SRAM), synchronous DRAM (SDRAM), PRAM, MRAM, or RRAM. In addition, in an embodiment, the memory 1100 may include at least one of a hard disk drive (HDD), a solid state drive (SSD), compact flash (CF), secure digital (SD), micro-SD, mini-SD, extreme digital (xD), and a memory stick. In an embodiment, the memory 1100 may semi-permanently or temporarily store algorithms, programs, and one or more instructions executed by the processor 1200.

The processor 1200 may control an overall operation of the motion recognizer 1000. The processor 1200 may include one or more of a central processing unit (CPU), an application processor (AP), and a communication processor (CP). The processor 1200 may perform, for example, an operation or data processing related to control and/or communication of at least one other component of the motion recognizer 1000.

The processor 1200 may execute a program stored in the memory 1100 to recognize the motion of the tag device. The processor 1200 may generate the position data of the tag device based on the time information. The processor 1200 may generate the final position data. In an embodiment, the processor 1200 may generate the final position data from the position data based on at least one of the first speed data and the position data of tag device.

The processor 1200 may identify the first abnormal position data in the position data based on the first speed data of the tag device. The processor 1200 may identify the second abnormal position data in the position data of the tag device based on the position data of the tag device and the anchor region. The processor 1200 may generate the final position data based on at least one of the first abnormal position data and the second abnormal position data.

The processor 1200 may correct the final position data. The processor 1200 may convert the motion path of the tag device represented by the final position data into an image. The processor 1200 may classify the image into one of preset movements by using the trained neural network model.

While example embodiments of the disclosure have been particularly shown and described, it will be understood that various changes in form and details may be made therein without departing from the spirit and scope of the following claims.

What is claimed is:

1. A tag device communicating with one or more anchor devices, the tag device comprising:
a first sensor;
a second sensor;
a pre-processor configured to:
generate first position data of the tag device based on time information sensed by at least one of a third sensor included in each of the one or more anchor devices and the first sensor of the tag device,
generate second position data based on first speed data of the tag device sensed by the second sensor and the first position data, and
generate an image based on a path of movement of the tag device based on the second position data in an operation period; and
a neural network processor configured to classify the image into one of a plurality of movements by using a trained neural network model.

2. The tag device of claim 1, wherein the pre-processor is further configured to:
identify first abnormal position data in the first position data based on the first speed data of the tag device, and
generate the second position data based on the first position data by excluding the first abnormal position data from the first position data.

3. The tag device of claim 2, wherein the pre-processor is further configured to:
obtain first speed values of the tag device based on the first speed data,
obtain second speed values of the tag device based on the first position data, and
compare the first speed values with the second speed values to identify the first abnormal position data.

4. The tag device of claim 3, wherein, based on a second speed value, among the second speed values, corresponding to a target point in time being greater than a first speed value, among the first speed values, corresponding to the target point in time, the pre-processor is further configured to determine that the first position data corresponding to the target point in time corresponds to the first abnormal position data.

5. The tag device of claim 1, wherein the pre-processor is further configured to:
identify second abnormal position data in the first position data based on the first position data of the tag device and positions of the one or more anchor devices and
generate the second position data based on the first position data by excluding the second abnormal position data from the first position data.

6. The tag device of claim 5, wherein, based on the first position data of the tag device corresponding to a target point in time corresponding to an outside of a region formed by the one or more anchor devices, the pre-processor is further configured to determine that the first position data corresponding to the target point in time corresponds to the second abnormal position data.

7. The tag device of claim 1, wherein the pre-processor is further configured to:
obtain a distance between each of the one or more anchor devices and the tag device based on the time information, and
generate the first position data of the tag device based on the distance.

8. The tag device of claim 1, wherein the image comprises a gray scale image.

9. The tag device of claim 1, wherein the pre-processor is further configured to:
generate a third position data by correcting the second position data by using a Kalman filter, and
generate the image based on the third position data.

10. The tag device of claim 1, wherein the trained neural network model is updated based on the image generated by the pre-processor.

11. The tag device of claim 1, wherein the time information comprises information in which a time for the first sensor of each of the one or more anchor devices and the first sensor of the tag device to transmit and receive an ultra-wideband (UWB) signal to and from each other is recorded.

12. A motion recognizer comprising:
a memory storing a program; and
at least one processor configured to execute the program to:
receive time information of a tag device from a first sensor and generate first position data of the tag device, the first position data comprising position values at a plurality of points in time included in an operation period,
receive first speed data of the tag device from a second sensor, the first speed data comprising acceleration values at the plurality of points in time and generates second position data of the operation period based on the position data and the first speed data,
generate an image based on a path of movement of the tag device based on the second position data of the operation period, and
classify the image into one of a plurality of movements by using a trained neural network model.

13. The motion recognizer of claim 12, wherein the at least one processor is further configured to:
obtain first speed values of the tag device at each of the plurality of points in time based on the first speed data,
obtain second speed values of the tag device at each of the plurality of points in time based on the position data, and
generate the second position data of the operation period based on comparison of the first speed value with the second speed value at each of the plurality of points in time.

14. The motion recognizer of claim 13, wherein the at least one processor is further configured to:
generate the second position data based on position values at points in time, among the plurality of points in time, at which a second speed value, among the second speed values, is less than or equal to a first speed value, among the first speed values.

15. The motion recognizer of claim 12, wherein the at least one processor is further configured to:
generate the second position data further based on positions of one or more anchor devices communicating with the tag device.

16. The motion recognizer of claim 15, wherein the at least one processor generates the second position data based on position values corresponding to a region formed by the one or more anchor devices among position values at the plurality of points in time.

17. The motion recognizer of claim 15, wherein the at least one processor is further configured to:
obtain a distance between each of the one or more anchor devices and the tag device corresponding to each of the plurality of points in time based on the time information, and obtain position values at the plurality of points in time based on a distance corresponding to each of the plurality of points in time.

18. The motion recognizer of claim 12, wherein the tag device further comprises a user input interface configured to receive a user input, and
wherein the operation period is set based on the user input.

19. A method of operating a tag device, the method comprising:
receiving time information of a tag device from a first sensor and generate first position data of the tag device, the first position data comprising position values at a plurality of points in time included in an operation period,
receiving first speed data of the tag device from a second sensor, the first speed data comprising acceleration values at the plurality of points in time and generates second position data of the operation period based on the position data and the first speed data,
generating an image based on a path of movement of the tag device based on the second position data of the operation period, and
classifying the image into one of a plurality of movements by using a trained neural network model.

20. The method of claim 19, wherein the generating the second position data further comprises:
obtaining a first speed value of the tag device based on the first speed data;
obtaining a second speed value of the tag device based on the position data; and
generating the second position data based on comparison of the first speed value with the second speed value.
